(19) United States
(12) Patent Application Publication
(10) Pub. No.: US 2016/0157248 A1
(43) Pub. Date: Jun. 2, 2016

(54) SUBFRAME CONFIGURATION FOR PERFORMING UL-DL INTERFERENCE MEASUREMENT IN GUARD PERIOD OF SPECIAL SUBFRAME FOR WIRELESS NETWORKS

(71) Applicant: NOKIA SOLUTIONS AND NETWORKS OY, Espoo (FI)

(72) Inventors: Jiezhen LIN, Beijing (CN); Haipeng LEI, Beijing (CN)

(21) Appl. No.: 14/905,549

(22) PCT Filed: Jul. 17, 2013
(86) PCT No.: PCT/CN2013/079538

§ 371 Date: Jan. 15, 2016

(51) Int. Cl. H04W 72/08; H04W 72/04

(52) U.S. Cl. CPC H04W 72/085; H04W 72/0426; H04W 72/0406

(57) ABSTRACT

Various example embodiments are disclosed herein. A technique is provided for selecting, by a measuring BS, a special subframe configuration to be used by the measuring BS for measuring interference from an interfering station, sending, by the measuring BS, a message to one or more other BSs, the message including a special subframe configuration code identifying the special subframe configuration to be used by the measuring BS, a cell ID of the interfering station and an interference type as either uplink (UL) interference or downlink (DL) interference, and measuring, by the measuring BS, interference from the interfering station during a guard period within one or more special subframes having the identified special subframe configuration. Also, the BS may notify one or more connected or attached MSs via downlink control information (DCI) of the special subframe configuration to be used by the BS.

### TECHNICAL FIELD

This description relates to wireless networks.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations, which are referred to as evolved Node Bs (eNBs), provide wireless access within a coverage area or cell. In LTE, mobile devices, or mobile stations are referred to as a user equipment (UE). LTE has included a number of improvements or developments.

### SUMMARY

According to an example implementation, a technique is provided for selecting, by a measuring BS, a special subframe configuration to be used by the measuring BS for measuring interference from an interfering station, sending, by the measuring BS, a message to one or more other BSs, the message including a special subframe configuration code identifying the special subframe configuration to be used by the measuring BS, a cell ID of the interfering station and an interference type as either uplink (UL) interference or downlink (DL) interference, and measuring, by the measuring BS, interference from the interfering station during a guard period within one or more special subframes having the identified special subframe configuration.

According to another example implementation, a technique is provided for receiving, by a neighbor BS from a measuring BS, a message including a special subframe configuration code identifying a first special subframe configuration to be used by the measuring BS to measure interference, a cell ID of an interfering station and an interference type as either uplink (UL) interference or downlink (DL) interference; comparing, by the neighbor BS, the cell ID of the interfering station to a cell ID of the neighbor BS that received the message; and performing, by the neighbor BS, the following if the cell ID of the interfering station is the same as the cell ID of the neighbor BS: selecting, if the interference type is downlink interference, a second special subframe configuration for use by the neighbor BS where the downlink pilot time slot (DwPTS) of the second special subframe configuration is longer than the DwPTS of the first special subframe configuration; and selecting, if the interference type is uplink interference, a third special subframe configuration for use by the neighbor BS where the uplink pilot time slot (UpPTS) of the third special subframe configuration is longer than the UpPTS of the first special subframe configuration.

In an example implementation, the technique may further include performing the following if the cell ID of the interfering station is not the same as the cell ID of the neighbor BS: selecting, if the interference type is downlink interference, a fourth special subframe configuration for use by the neighbor BS where the DwPTS of the fourth special subframe configuration is not longer than the DwPTS of the first special subframe configuration; and selecting, if the interference type is uplink interference, a fifth special subframe configuration for use by the neighbor BS where the UpPTS of the fifth special subframe configuration is not longer than the UpPTS of the first special subframe configuration.

According to yet another example implementation, a technique is provided for selecting, by a measuring BS, a first special subframe configuration to be used by an interfering station; sending, by the measuring BS, a message to one or more other BSs, the message including a special subframe configuration code identifying the first special subframe configuration to be used by the interfering station, a cell ID of the interfering station and an interference type as either uplink (UL) interference or downlink (DL) interference; selecting, by the measuring BS, a second special subframe configuration to be used by the measuring BS, wherein the second special subframe configuration includes a guard period that is longer than a guard period of the first special subframe; and measuring, by the measuring BS, interference from the interfering station during the guard period of one or more special subframes used by the measuring BS.

According to yet another example implementation, a technique is provided for receiving, by a neighbor BS from a measuring BS, a message including a special subframe configuration code identifying a first special subframe configuration to be used by an interfering station, a cell ID of an interfering station and an interference type as either uplink (UL) interference or downlink (DL) interference; comparing, by the neighbor BS, the cell ID of the interfering station to a cell ID of the neighbor BS that received the message; and selecting the first special subframe configuration for use by the neighbor BS if the cell ID of the interfering station is the same as the cell ID of the neighbor BS.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network 102 according to an example implementation.

FIG. 2 is a diagram of example special subframes that may used by a measuring BS and an interfering BS/cell to allow DL interference to be measured according to an example implementation.

FIG. 3 is a diagram of example special subframes that may used by a measuring BS and an interfering cell to allow UL interference to be measured according to an example implementation.

FIG. 4 is a diagram illustrating an example of this message that may be sent by the measuring BS to neighbor BSs according to an example implementation.

FIG. 5 is a flow chart illustrating operation of a BS according to an example implementation.

FIG. 6 is a flow chart illustrating operation of a BS according to another example implementation.

FIG. 7 is a flow chart illustrating operation of a BS according to another example implementation.

FIG. 8 is a flow chart illustrating operation of a BS according to yet another example implementation.

FIG. 9 is a block diagram of a wireless station (e.g., BS or MS) 600 according to an example implementation.

FIG. 10 is a flow chart illustrating operation of a BS according to yet another example implementation.

### DETAILED DESCRIPTION

According to an example implementation, within a radio frame, a special subframe may serve as a switching point from downlink (DL) to uplink (UL) transmission, and may include, for example, three fields including: 1) a downlink pilot time slot (DwPTS), which may be considered as a short downlink subframe in which downlink data or signals may be transmitted from the BS to the MSs; 2) a guard period (GP) during which no transmission (either UL or DL) occurs; and 3) an uplink pilot time slot (UpPTS) in which uplink data or signals may be transmitted. According to an example implementation, a measuring BS may receive/measure UL or DL interference during a GP of a special subframe.

According to an example implementation, various techniques are described for communicating and/or coordinating the special subframe configurations to be used by a measuring base station (BS) and a measured/interfering cell/BS so as to allow the measuring BS to measure UL interference or DL interference from a measured/interfering cell or BS during a GP of a special subframe used by the measuring BS. This may be accomplished, for example, by selecting or using different special subframe configurations for the measuring BS and the measured/interfering BS/cell so that at least a portion of the DL interference signal (e.g., signals or data transmitted within a DwPTS) or a portion of the UL interference signal (e.g., signals or data transmitted within a UpPTS) of a special subframe transmitted by the measured/interfering cell/BS overlaps (and therefore may be received/measured during) a portion of a GP of a special subframe configuration used by the measuring BS.

According to an example implementation, a receiving BS may adjust a special subframe configuration to accommodate the measurements performed by a measuring BS. For example, the receiving BSs may adjust their special subframe configurations for DwPTS:GP:UpPTS to accommodate the special subframe configuration of the measuring BS.

According to an example implementation, special subframe configurations may be selected such that a DL interference signal (e.g., DwPTS) or an UL interference signal (e.g., UpPTS) of the special subframe configuration(s) used by a measured/interfering BS are longer than the same signals of the special subframes used by the measuring BS. Also, the guard period (GP) of the special subframe configuration used by the measured/interfering cell/BS may be shorter than the GP of the special subframe configuration used by the measuring BS. In this manner, the interference signal (e.g., DwPTS for downlink measurement, and UpPTS for uplink interference measurement) of the measured/interfering BS/cell may at least partially overlap a GP of the special subframe used by the measuring BS.

Also, other (non-measured) BSs that are adjacent (or neighbors) to the measuring BS (e.g., non-measured neighbor BSs) may be quieted during the GP of the measuring BS to avoid disturbing the measurement. To accomplish this, the non-measured neighbor BSs may use special subframe configurations that have interfering signals (e.g., DwPTS or UpPTS) that are not longer than the same interfering signals of the measuring BS.

In addition, a message may be sent by a measuring BS to one or more (or all) neighbor BSs to communicate a special subframe configuration to be used by the measuring BS and/or to communicate a special subframe configuration to be used by the measured/interfering BS/cell during a measurement period or duration, a cell ID to identify a cell of the measured/interfering station, and an indication of either UL or DL interference to be measured. The receiving BSs may then select an appropriate special subframe configuration, either (depending on the implementation) a specified special subframe configuration, or a configuration that would allow the interference measurement to be accomplished without interference by non-measured BSs during the GP of the measuring BS.

In cellular wireless systems, a base station (or evolved Node B, or eNB) typically provides wireless services within a cell or area. For example, some cells may provide wide coverage areas, while other cells may provide smaller coverage areas. Although LTE is used as an example wireless network, the various aspects or details described herein may be applicable to any wireless technology or standard.

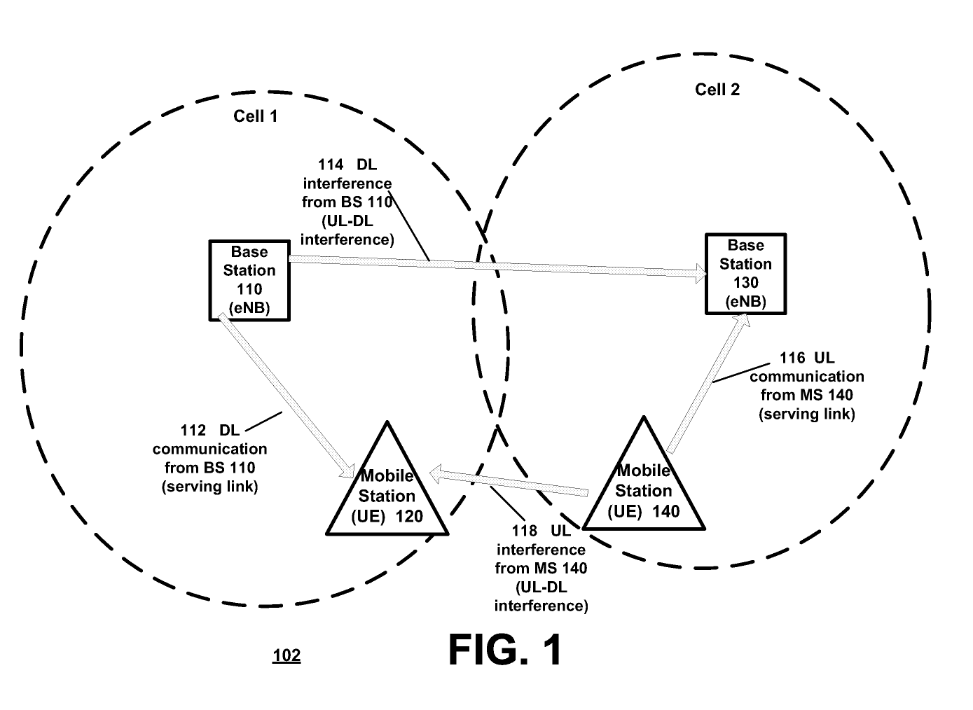

FIG. 1 is a block diagram of a wireless network 102 according to an example implementation. In the wireless network 102 of FIG. 1, two example cells are illustrated, including cell 1 and cell 2. Base station (BS) 110 provides wireless coverage within cell 1, while BS 130 provides wireless coverage within cell 2. One or more mobile stations (MSs, or UEs) may be connected to or associated with each BS. For example, MS 120 may be connected to and/or in communication with BS 110, while MS 140 may be connected to and/or in communication with BS 130.

In LTE Time Division Duplex (TDD) mode (also known as TD-LTE), uplink (MS-to-BS) and downlink (BS-to-MS) communication takes place in the same frequency band but in separately non-overlapping time slots. Thus, in LTE TDD operation, there is a single carrier frequency and uplink and downlink transmissions are separated in the time domain on a cell basis, e.g., within each cell.

There are several different LTE frame configurations for UL-DL allocation of subframes. Each LTE radio frame may include 10 subframes (for example). A LTE frame may be 10 ms, with each subframe being 1 ms in length, for example. Each subframe within the radio frame may be either a downlink subframe, an uplink subframe, or a special subframe. In a downlink subframe, downlink control information and data are transmitted from the BS to the MSs within that cell. Each downlink frame transmitted by the BS may include control information, such as cell-specific reference signals (CRS), which may be used by the MS for channel estimation for coherent demodulation, used by the MS to acquire channel state information, and measurements of the CRS by the MS may be used as a basis for cell selection and handover, for example. Also, according to an example implementation, the downlink CRS signals may be used by a measuring BS to measure DL interference from another BS, as described in greater detail herein. In an uplink subframe, MSs within the cell may transmit data to the BS.

A special subframe may serve as a switching point from downlink (DL) to uplink (UL) transmission, and typically contains three fields including: 1) a downlink pilot time slot (DwPTS), which may be considered as a short downlink subframe in which downlink data may be transmitted from the BS to the MSs. CRS signals (for example), or other DL signals, may be transmitted by a BS during the DwPTS of a special subframe to MSs of the cell, and may also sometimes be inadvertently received by MSs or BS in one or more neighbor or adjacent cells as DL interference. 2) a guard period (GP) during which no transmission (either UL or DL) occurs; and 3) an uplink pilot time slot (UpPTS), which may typically include one or two (or more) OFDM (orthogonal frequency division multiplexing) symbols to allow the MS to transmit sounding signals or performing random access to a BS during the UpPTS. The uplink signals transmitted by a MS to its associated BS during the UpPTS of a special subframe, and other UL signals, may in some cases also be inadvertently received by a neighbor BS (and possibly MSs within that neighbor cell) as UL interference.

Table 1 below illustrates some example radio frame configurations (UL/DL configurations 0-6), illustrating the allocation of UL, DL or special subframe to each of the 10 subframes (subframes 0-9). In Table 1, U, D and S indicate uplink subframe, downlink subframe and special subframe, respectively. The switching point periodicity is shown as either 5 ms or 10 ms. According to an example implementation, subframes 0 and 5 are downlink subframes, subframe 2 is an uplink subframe, and subframe 1 and subframe 6 (at least in some cases) are special subframes. The remaining subframes (e.g., subframes 3, 4, and 7-9) are flexible and may be assigned as either uplink or downlink subframes, depending on the radio frame UL/DL configuration. For example, with such a flexible radio frame reconfiguration, more subframes may be assigned as uplink subframes when uplink resource demand has increased, and more subframes may be assigned as downlink subframes when the BS has greater demands for downlink resources. A BS may, for example, notify the MSs in the cell (MSs attached to the BS) of the radio frame configuration to be used within the cell via downlink control information (DCI), and the radio frame configuration may be changed by the BS.

TABLE 1
Example Radio Frame Configurations

| | Sw. | | | | | | | | | | |
|---|---|---|---|---|---|---|---|---|---|---|---|
| Frame | Pt | Subframe Number | | | | | | | | | |
| Config | Per. | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

However, different cells may be implementing different radio frame UL/DL configurations for traffic adaptation within each cell. When this happens, UL-DL interference may occur between adjacent cells. Table 2 illustrates an example where UL-DL interference may occur between cell 1 and cell 2.

TABLE 2
Radio Frame configurations for cell 1, cell
2 illustrating example UL-DL interference

| subframe | 0 | 1 | 2 | 3 | 4 | 5 | 6 | 7 | 8 | 9 |
|---|---|---|---|---|---|---|---|---|---|---|
| Cell 1: Frame | D | S | U | D | D | D | S | U | D | D |
| Config. #2 | | | | | | | | | | |
| Cell 2: Frame | D | S | U | U | D | D | S | U | U | D |
| Config. #1 | | | | | | | | | | |

As shown in Table 2, cell 1 may be using UL/DL configuration (radio frame configuration) 2, while cell 2 may be using radio frame configuration 1 (see also Table 1). Thus, as shown by Table 1, cell 1 BS may be, for example, transmitting in a DL direction, while cell 2 (or a MS within cell 2) is transmitting in an UL direction for subframes 3 and 8. A similar, but opposite, interference may occur if cell 1 is transmitting UL while cell 2 is transmitting DL at the same time.

An example UL-DL interference is illustrated in FIG. 1. In this example, BS 110 of cell 1 may be transmitting DL to MS 120 via DL communication 112. This DL transmission from BS 110 may result in a DL signal 114 being (inadvertently) received by neighbor (or adjacent) BS 130 via DL interference signal 114. This DL interference signal 114 from BS 110 may be received at BS 130 at the same time (or within the same subframe) that MS 140 is UL transmitting to BS 130 via UL communication signal 116, wherein both UL communication signal 116 and DL interference signal 114 are provided on the same frequency band in TDD, for example. Similarly, when MS 140 is transmitting UL to BS 130 via UL communication signal 116, UL interference signal 118 may inadvertently be received by MS 120 at the same time that DL communication signal 112 is received by MS 120 from BS 110. These are two examples of UL-DL interference which may negatively impact the performance of TDD wireless networks.

Therefore, DL interference signal 114 and UL interference signal 118 are examples of UL-DL interference between neighbor cells within a TDD system. Such interference signals may decrease wireless network performance, e.g., by making it more difficult for the receiving station to correctly receive the (non-interference) data signal. According to an example implementation, once the interference has been detected and/or measured, the measuring BS or measuring cell may address or mitigate the interference, e.g., by sending a request or instruction to the interfering cell to decrease transmission power, or to request the interfering cell/BS to switch to a different (non-interfering) radio frame configuration, for example, or other technique to decrease the UL-DL interference. Thus, detecting and/or measuring (e.g., measuring an amplitude) of the UL-DL interference may be a first important step in addressing or attempting to mitigate such UL-DL interference and improving performance of TDD wireless networks.

Therefore, according to an example implementation, a BS may measure interference from an adjacent or neighbor cell by measuring UL or DL interference during a guard period (GP) within a special subframe. As noted above, a special subframe includes three fields including: 1) a downlink pilot time slot (DwPTS), 2) a guard period (GP), during which no transmission occurs, and 3) an uplink pilot time slot (UpPTS). According to an example implementation, there may be several different special subframe configurations, wherein a different number of OFDM symbols may be allocated to each of the three fields for each special subframe configuration.

Table 3 illustrates different special subframe configurations according to an illustrative example implementation. In Table 3, for each special subframe configuration, a special subframe configuration code (or index) (e.g., 0, 1, 2, 3, . . . 9), along with the number of OFDM symbols for the DwPTS, GP and UpPTS fields are identified. Special subframe configurations are shown for both a normal cyclic prefix (CP) and an extended CR For example, as shown in Table 3, a special subframe configuration code (or index) of zero (0) corresponds to a DwPTS of 3 symbols, a GP of 10 symbols and a UpPTS for 1 symbol, for normal CP. The number of OFDM symbols for the three fields of a special subframe are also identified for other special subframe configurations.

TABLE 3
Example special subframe configurations

| | | | |
|---|---|---|---|
| Config- | Normal CP | Extended | CP |

| uration | DwPT | GP | UpPT | DwPT | GP | UpPT |
|---|---|---|---|---|---|---|
| 0 | 3 | 10 | 1 | 3 | 8 | 1 |
| 1 | 9 | 4 | 1 | 8 | 3 | 1 |
| 2 | 10 | 3 | 1 | 9 | 2 | 1 |
| 3 | 11 | 2 | 1 | 10 | 1 | 1 |
| 4 | 12 | 1 | 1 | 3 | 7 | 2 |
| 5 | 3 | 9 | 2 | 8 | 2 | 2 |
| 6 | 9 | 3 | 2 | 9 | 1 | 2 |
| 7 | 10 | 2 | 2 | 5 | 5 | 2 |
| 8 | 11 | 1 | 2 | | | |
| 9 | 6 | 6 | 2 | | | |

Each cell or BS may use a different special subframe configuration, and the special subframe configuration used by each cell may change over time. Each BS may communicate the special subframe configuration that is being used by that cell to the MSs of that cell, e.g., via downlink control information (DCI) or other control signal provided in one or more downlink subframes, e.g., subframe 0. This communication of the current special subframe configuration used by the cell/BS to the associated MSs allows the timing or length of the three fields of the special subframe (DwPTS, GP and UpPTS) within the cell to be synchronized between MSs and BS of that cell.

According to an example implementation, a (measuring) BS may measure interference from an adjacent (or measured/interfering) cell, e.g., as either a DwPTS or an UpPTS, that is received by the measuring BS from the adjacent cell during a guard period (GP) of a special subframe used by the measuring BS. Each cell may use a different special subframe configuration. To allow a measuring BS to measure the UL or DL interference from a neighbor (or adjacent cell), the special subframe configurations between the measuring cell and interfering cell may be coordinated such that the interfering signal (e.g., signals or data transmitted via the DwPTS for DL interference from a BS, or signals or data transmitted via the UpPTS for UL interference from a MS of measured/interfering cell) transmitted by the interfering cell overlaps at least a portion of the guard period (GP) of the special subframe used by the measuring cell/BS.

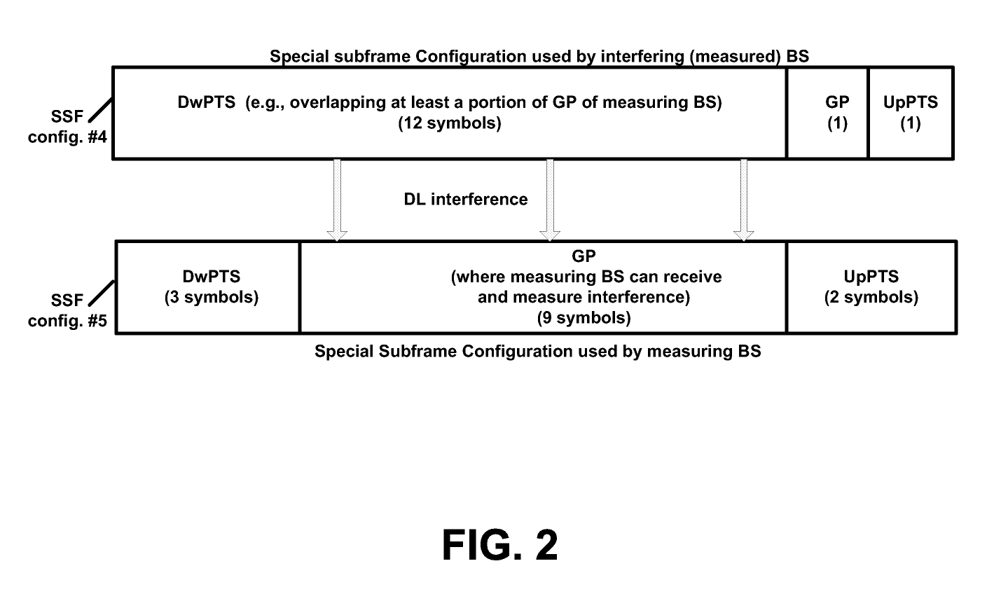

FIG. 2 is a diagram of example special subframes that may used by a measuring BS and an interfering BS/cell to allow DL interference to be measured according to an example implementation. In this illustrative example, the measuring BS would like to measure downlink interference (e.g., the DwPTS) from a neighbor BS during a GP of the special subframe used by the measuring BS. Therefore, in this example, the measuring BS may use a special subframe configuration having a relatively short DwPTS and a relatively long guard period (GP), such as special subframe configuration 5 which may include a DwPTS of 3 symbols, a GP of 9 symbols, and a UpPTS of 2 symbols, as an example.

In contrast, it may be desirable for the interfering (measured) BS to use a special subframe configuration that has a longer DwPTS and a shorter GP than the measuring BS, e.g., to allow the signals or data transmitted by the measured/interfering BS in its DwPTS to be received and measured by the measuring BS during a GP of the special subframe of the measuring BS. In the example shown in FIG. 2, the interfering/measured BS is using a special subframe configuration 4 that includes a DwPTS of 12 symbols, a GP of 1 symbol and an UpPTS of 1 symbol. Therefore, in this example, the 12 symbol DwPTS of the measured/interfering BS overlaps the 3 symbol DwPTS and 9 symbol GP of the measuring BS, to allow for 9 symbols of DwPTS (interference) to be received and measured by the measuring BS during the 9 symbol GP. This is merely one illustrative example how different special subframe configurations may be used by a measured BS and a measuring BS, to allow for the measuring BS to receive/measure interference via DwPTS or UpPTS during a GP of the measuring BS.

According to an example implementation, other (non-measured) neighbor BSs which are not being measured preferably should not be transmitting during the GP of the measuring BS. Therefore, the other neighbor (non-measured) BSs should use a special subframe configuration with a GP at least as long as the measuring BS, and/or a DwPTS (or interfering signal) that is not longer (e.g., same as or shorter) than the DwPTS (or interfering signal) of the measuring BS, e.g., so that the measured/interfering BS is the only neighbor transmitting during the GP (or at least the measuring portion of the GP) of the measuring BS, for example, in order to obtain an accurate measurement of an amplitude or power of the interference from the measured/interfering BS, without receiving an unintended interference contribution from a non-measured neighbor BS during this GP of the measuring BS. Similarly, according to an example implementation, for uplink interference, non-measured neighbor BSs should use a special subframe configuration that includes a UpPTS that is not longer (e.g., same as or shorter) than the UpPTS of the measuring BS. Also, according to an example implementation, the GP used by the non-measured BS may (or should) be the same or longer than the GP used by the measuring BS.

While the example shown in FIG. 2 illustrates use of special subframe configurations to allow downlink interference to be received during a GP of a measuring BS, a similar approach may be used to allow uplink interference to be measured during a GP of a measuring BS. In such a case, the measuring BS should use a special subframe configuration that includes a GP that is longer than the GP of the measured BS. Also, to measure UL interference, and to facilitate overlap between UpPTS of the measured BS and a GP of the measuring BS, the measured BS may use a special subframe configuration that has a UpPTS that is longer than the UpPTS of the measuring BS.

Table 4 illustrates some additional special subframe configurations (e.g., configurations 10-15) that may include some long (or longer) UpPTS fields, e.g., to allow a measuring BS to measure more than two OFDM symbols of UL interference from an interfering cell (UL interference/UpPTS from a MS of the interfering cell/BS). For example, special subframe configuration 10 may have a special subframe configuration code (or index) of 10, a DwPTS of 3 symbols, a GP of 1 symbol and a UpPTS of 10 symbols.

TABLE 4
Additional special subframe configurations
with longer UpPTS fields

| Configuration | DwPTS (Number | GP (Number | UpPTS (Number |
|---|---|---|---|
| code or index | of symbols) | of symbols) | of symbols) |
| 10 | 3 | 1 | 10 |
| 11 | 5 | 1 | 8 |
| 12 | 7 | 1 | 6 |
| 13 | 9 | 1 | 4 |
| 14 | 3 | 2 | 9 |
| 15 | 5 | 2 | 7 |

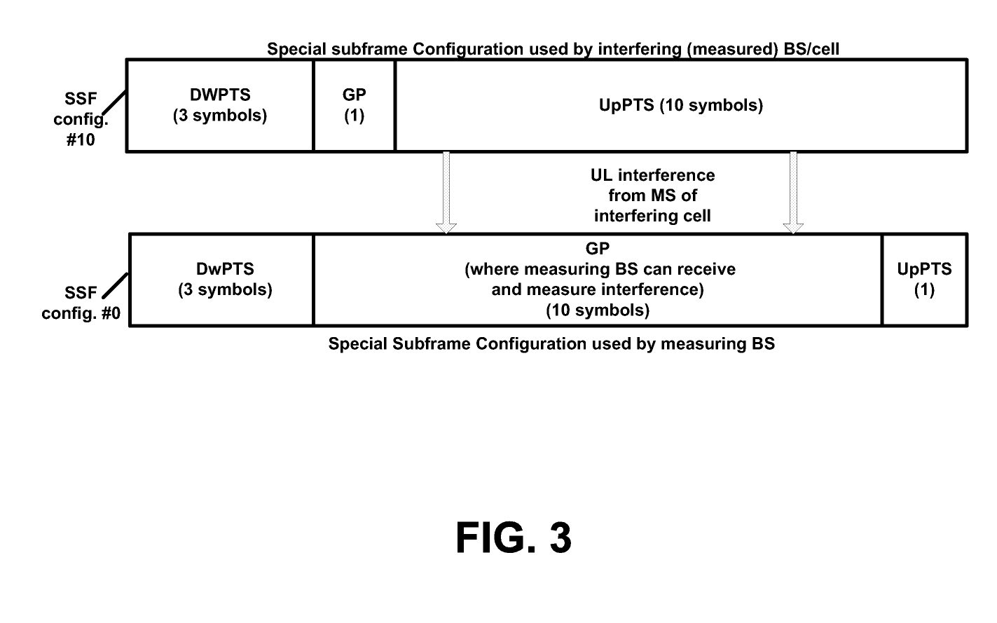

FIG. 3 is a diagram of example special subframes that may be used by a measuring BS and an interfering cell to allow UL interference to be measured according to an example implementation. In this illustrative example, the measuring BS would like to measure uplink interference (e.g., the UpPTS) from a neighbor (measured) cell during a GP of the special subframe used by the measuring BS. Therefore, in this example, the measuring BS may use a special subframe configuration having a relatively short UpPTS and a relatively long guard period (GP), such as special subframe configuration 0 which may include a DwPTS of 3 symbols, a GP of 10 symbols, and a UpPTS of 1 symbol. In contrast, it may be desirable for the interfering (measured) cell/BS to use a special subframe configuration that has a longer UpPTS and a shorter GP than the measuring BS, e.g., to allow the signals transmitted in the UpPTS by a MS of the measured/interfering cell/BS to be received and measured by the measuring BS during a GP of the special subframe of the measuring BS. In the example shown in FIG. 3, the interfering/measured cell/BS is using a special subframe configuration 10 that includes a DwPTS of 3 symbols, a GP of 1 symbol and an UpPTS of 10 symbols. Therefore, in this example, the 10 symbol UpPTS of the measured/interfering cell includes 8 symbols that overlap the GP of the measuring BS. This is merely one illustrative example, and other special subframe configurations may be used.

While the UL interference example shown in FIG. 3 may use one of the additional subframe configurations with a long UpPTS for the measured/interfering cell/BS shown in Table 4, the UL interference measurement may also be performed with BSs/cells using only those special subframe configurations shown in Table 3, e.g., where a measured cell/BS may use a special subframe configuration with a long UpPTS (2 symbols) and the measuring cell BS may use a special subframe configuration with a GP that is longer and/or a UpPTS that is shorter (e.g., 1 symbol UpPTS) than the measured/interfering cell/BS.

Note that UL interference (transmission of the UpPTS signals) may involve a measured/interfering BS selecting a special subframe configuration, and then sending a message (e.g., via downlink control information or DCI, or other control signaling) to one or more MSs within its cell (MSs attached to the BS) to indicate the selected special subframe configuration to be used by the measured BS and MSs within that cell. The measured BS may then schedule (or may allow) a MS within the measured cell to then transmit signals during the UpPTS. These UpPTS signals may then, at least in some cases, be received as UL interference at the measuring BS and/or one or more MSs within the cell of the measuring BS. The measuring BS may then receive and measure the UpPTS signals during a GP of its special subframe to determine the amount (e.g., amplitude or power) of the UL interference from this neighbor measured cell, for example. In some cases, the measuring BS may then take steps, if necessary, to mitigate the interference, e.g., by sending a message to the BS of the interfering/measured cell to request a transmission power reduction or to request that the interfering BS switch to a different special subframe configuration(s), as examples.

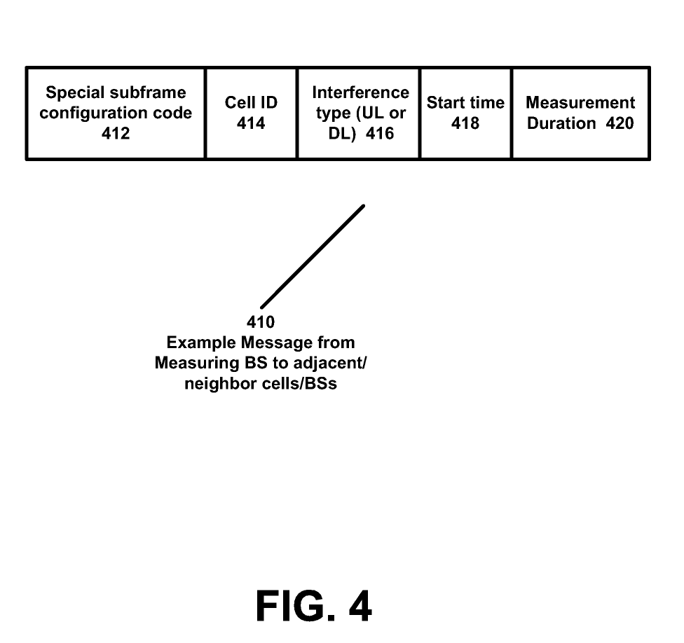

Different techniques or implementations may be used to coordinate the special subframes to be used by a measuring cell/BS and the interfering cell/BS (or the cell from which interference will be measured by the measuring BS or cell). According to a first example implementation, the measuring BS may send a message via X2 interface to one or more (or all) the neighbor/adjacent cells or BSs. FIG. 4 is a diagram illustrating an example of this message that may be sent by the measuring BS to neighbor BSs according to an example implementation. Message 410, which may be sent by the measuring BS to BSs of neighbor/adjacent cells, may include a special subframe configuration code 412 to identify the special subframe configuration used by the measuring BS. Alternatively, the special subframe configuration code 412 may identify the special subframe configuration to be used by an interfering/measured cell/BS. In yet another example implementation, the message 410 may include both a first special subframe configuration code to identify the special subframe configuration used by a measuring BS and a second special subframe configuration code to identify the special subframe configuration to be used by the measured/interfering BS/cell (which is identified by the cell ID 414).

Referring again to FIG. 4, the message 410 may also include a cell ID 414 to identify the measured/interfering cell to be measured, an interference type 416 (as either UL interference via measurement of UpPTS, or DL interference via measurement of DwPTS). The message 410 may also identify the measurement period (e.g., a period of time or a number of frames or other period over which the DL or UL interference will be measured, and during which the identified special subframe configuration(s) should be used/maintained) via one or more fields. For example, message 410 may include a start time 418 that identifies a start time or start frame number or other start indication at which the interference measurement will begin, and a measurement duration 420 which may be a time duration or a duration as a number of frames or other duration over which the interference measurement will be performed and over which the BSs should use the specified or determined special subframe configurations to allow the measurement to be performed.

A measurement period or duration may last or extend over, for example, 1 radio frame, or over multiple radio frames, e.g., 2, 3, 4, 5, 6 or more radio frames. Note, that while the special subframe configurations should be maintained during the measurement period or duration, the frame configuration (e.g., UL/DL frame configurations of Table 1) of each cell during such measurement period may be changed, since the special subframe (e.g., subframe 1 and possibly subframe 6) will not change, even though a radio frame (UL/DL) configuration may change for traffic adaptation. Thus, the interference measurement may be performed during the special subframe(s), e.g., subframes 1 and/or 6, of each radio frame within the measurement period or duration.

Also, each BS should send a message to notify the MSs attached to the BS of any change in a radio frame (UL/DL) configuration for the cell or of any changes to a special subframe configuration for the cell. A special subframe configuration indication may be carried in the DCI (downlink control information), and four bits of the DCI may be used to indicate to the attached MSs the special subframe configuration(s) adopted or to be adopted by the cell. For legacy MSs, a special subframe configuration with a long GP (e.g., special subframe configurations 0 or 5 for normal CP) may be indicated to attached MSs via SIB-1 (system information block) signaling. According to one example implementation, the mobile stations may indicate their capability of supporting the DCI indicator of special subframe configuration and the BS may identify the mobile stations which support the DCI indicator of special subframe configuration.

An illustrative example implementation may be the DCI (downlink control information) format 1C carried in common search space be used by a BS to indicate the special subframe configuration to attached/connected MSs, e.g., due to the small size and high reliability of this format 1C. Hence, according to an example implementation, a special subframe (SSF) configuration (e.g., a special subframe configuration code for implemented SSF configuration) can be carried in the DCI format 1C together with a TDD UL-DL configuration (radio frame configuration) in a single DL subframe. For example, four bits contained in the DCI format 1C may be reused to dynamically indicate to MSs the special subframe configuration that has been adopted or selected by a BS. For example, the RB assignment field or the MCS field can be reused to indicate one of several special subframe configurations that have been selected or adopted by a BS. Regarding backwards compatibility with legacy MSs (e.g., MSs which may not be aware or have capability of adapting special subframe configurations for interference measurement), a special subframe configuration with a long GP (e.g., SSF configurations 0 or 5 for normal CP) may be indicated in SIB-1 signaling to legacy MSs, so there is no impact on legacy MS operation, and the legacy MSs will not impact or affect the interference measurement, due to long GP used by such legacy MSs.

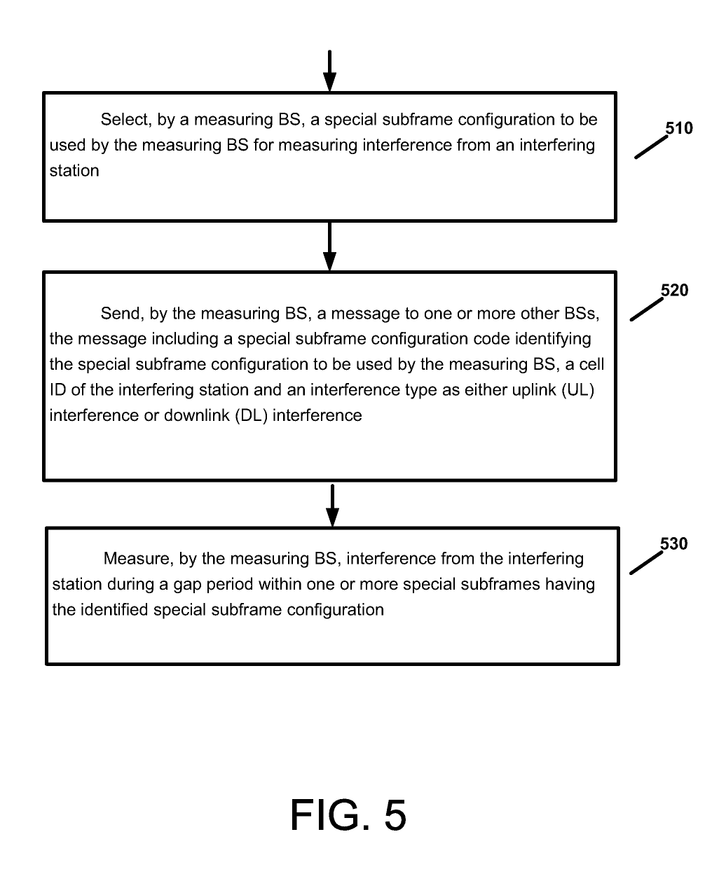

FIG. 5 is a flow chart illustrating operation of a measuring BS according to an example implementation. At 510, a measuring BS selects a special subframe configuration to be used by the measuring BS for measuring interference from an interfering station. At 520, the measuring BS sends a message to one or more other BSs, the message including a special subframe configuration code identifying the special subframe configuration to be used by the measuring BS, a cell ID of the interfering station and an interference type as either uplink (UL) interference or downlink (DL) interference. At 530, the measuring BS measures interference from the interfering station during a guard period within one or more special subframes having the identified special subframe configuration.

In the method of FIG. 5, the message may further include a start time and a measurement duration for the measuring of the interference from the interfering station.

In the method of FIG. 5, the special subframe configuration code may include a first special subframe configuration code identifying the special subframe configuration to be used by the measuring BS, the message further including a second special subframe configuration code identifying a special subframe configuration to be used by an interfering BS during the measuring of the interference. In an example implementation, the first special subframe configuration includes a guard period that is longer than a guard period of the second special subframe configuration. In another example implementation, the interference type may include downlink interference, and wherein a downlink pilot time slot (DwPTS) of the second special subframe configuration used by the interfering BS is longer than the DwPTS of the first special subframe configuration used by the measuring BS such that at least a portion of the DwPTS of the second special subframe configuration overlaps at least a portion of a guard period of the first special subframe configuration. In another example implementation, the interference type may include uplink interference, and wherein an uplink pilot time slot (UpPTS) of the second special subframe configuration used by the interfering BS is longer than a UpPTS of the first special subframe configuration used by the measuring BS such that at least a portion of the UpPTS of the second special subframe configuration overlaps at least a portion of a guard period of the first special subframe configuration.

In the method of FIG. 5, the interference type may include downlink interference, and wherein the interfering station may include a base station associated with the cell ID. In an example implementation, the interference type may include uplink interference, and wherein the interfering station includes a mobile station operating in a cell associated with the cell ID.

According to another example implementation, an apparatus is provided that may include at least one processor and at least one memory including computer instructions, when executed by the at least one processor, cause the apparatus to: select, by a measuring BS, a special subframe configuration to be used by the measuring BS for measuring interference from an interfering station; send, by the measuring BS, a message to one or more other BSs, the message including a special subframe configuration code identifying the special subframe configuration to be used by the measuring BS, a cell ID of the interfering station and an interference type as either uplink (UL) interference or downlink (DL) interference; and measure, by the measuring BS, interference from the interfering station during a guard period within one or more special subframes having the identified special subframe configuration.

According to yet another example implementation, a computer program product is provided. The computer program product includes a non-transitory computer-readable storage medium and storing executable code that, when executed by at least one data processing apparatus, is configured to cause the at least one data processing apparatus to perform a method that includes: selecting, by a measuring BS, a special subframe configuration to be used by the measuring BS for measuring interference from an interfering station; sending, by the measuring BS, a message to one or more other BSs, the message including a special subframe configuration code identifying the special subframe configuration to be used by the measuring BS, a cell ID of the interfering station and an interference type as either uplink (UL) interference or downlink (DL) interference; and measuring, by the measuring BS, interference from the interfering station during a guard period within one or more special subframes having the identified special subframe configuration.

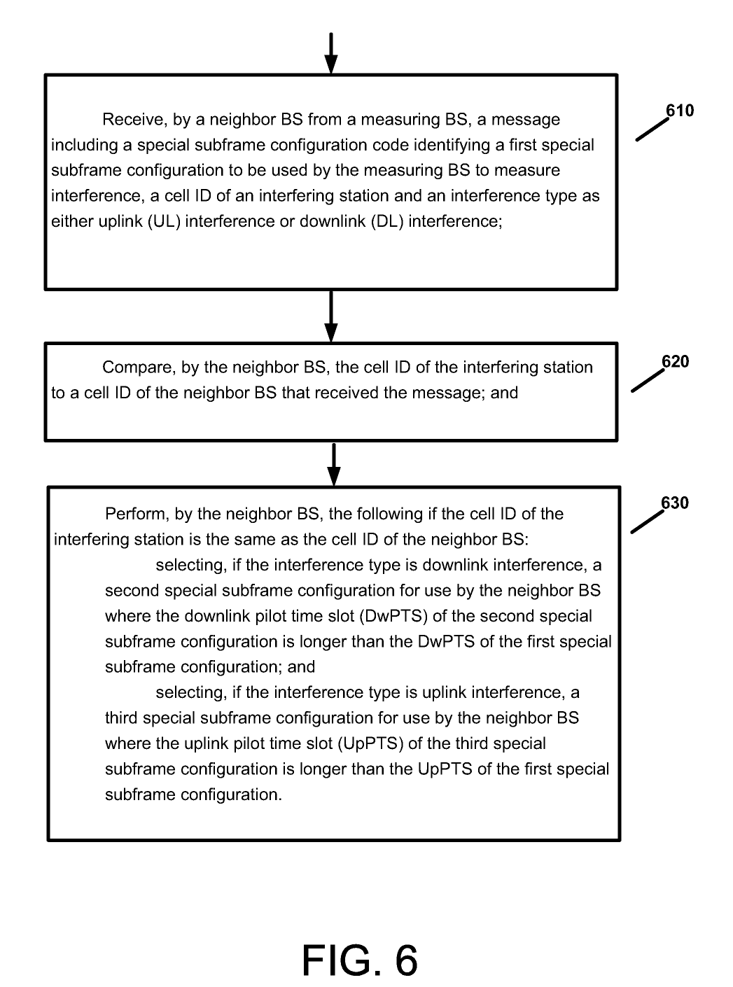

FIG. 6 is a flow chart illustrating operation of a BS according to an example implementation. At 610, a neighbor BS receives from a measuring BS, a message including a special subframe configuration code identifying a first special subframe configuration to be used by the measuring BS to measure interference, a cell ID of an interfering station and an interference type as either uplink (UL) interference or downlink (DL) interference. At 620, the neighbor BS compares the cell ID of the interfering station to a cell ID of the neighbor BS that received the message. At 630, the neighbor BS performs the following if the cell ID of the interfering station is the same as the cell ID of the neighbor BS: selecting, if the interference type is downlink interference, a second special subframe configuration for use by the neighbor BS where the downlink pilot time slot (DwPTS) of the second special subframe configuration is longer than the DwPTS of the first special subframe configuration; and selecting, if the interference type is uplink interference, a third special subframe configuration for use by the neighbor BS where the uplink pilot time slot (UpPTS) of the third special subframe configuration is longer than the UpPTS of the first special subframe configuration.

The method of FIG. 6 may further include performing the following if the cell ID of the interfering station is not the same as the cell ID of the neighbor BS: selecting, if the interference type is downlink interference, a fourth special subframe configuration for use by the neighbor BS where the DwPTS of the fourth special subframe configuration is not longer than the DwPTS of the first special subframe configuration; and selecting, if the interference type is uplink interference, a fifth special subframe configuration for use by the neighbor BS where the UpPTS of the fifth special subframe configuration is not longer than the UpPTS of the first special subframe configuration.

In the method of FIG. 6, according to an example implementation, at least a portion of a guard period of a special subframe having the first special subframe configuration overlaps at least a portion of the DwPTS of a subframe having the second special subframe configuration if the interference type is downlink interference to allow the measuring BS to measure the DwPTS from the neighbor BS during the guard period of the special subframe used by the measuring BS.

In the method of FIG. 6, according to an example implementation, at least a portion of a guard period of a special subframe having the first special subframe configuration overlaps at least a portion of the UpPTS of a subframe having the third special subframe configuration if the interference type is uplink to allow the measuring BS to measure the UpPTS from a mobile station (MS) associated with the neighbor (measured/interfering) BS during a guard period of the special subframe having the third special subframe configuration used by the measuring BS.

In the method of FIG. 6, the message may further include a start time and a measurement duration for the measuring of the interference from the interfering station.

In the method of FIG. 6, the method may further include the neighbor BS notifying one or more mobile stations (MSs) of the special subframe configuration selected by the neighbor BS for use by the neighbor BS.

In the method of FIG. 6, according to an example implementation, the interference type is uplink interference, and the method further includes the neighbor BS scheduling a mobile station associated with the neighbor BS to transmit during the UpPTS of one or more special subframes having the special subframe configuration selected by the neighbor BS for use by the neighbor BS.

According to another example implementation, an apparatus includes at least one processor and at least one memory including computer instructions, when executed by the at least one processor, cause the apparatus to: receive, by a neighbor BS from a measuring BS, a message including a special subframe configuration code identifying a first special subframe configuration to be used by the measuring BS to measure interference, a cell ID of an interfering station and an interference type as either uplink (UL) interference or downlink (DL) interference; compare, by the neighbor BS, the cell ID of the interfering station to a cell ID of the neighbor BS that received the message; and perform, by the neighbor BS, the following if the cell ID of the interfering station is the same as the cell ID of the neighbor BS: select, if the interference type is downlink interference, a second special subframe configuration for use by the neighbor BS where the downlink pilot time slot (DwPTS) of the second special subframe configuration is longer than the DwPTS of the first special subframe configuration; and select, if the interference type is uplink interference, a third special subframe configuration for use by the neighbor BS where the uplink pilot time slot (UpPTS) of the third special subframe configuration is longer than the UpPTS of the first special subframe configuration.

According to another example implementation, a computer program product is provided. The computer program product includes a non-transitory computer-readable storage medium and storing executable code that, when executed by at least one data processing apparatus, is configured to cause the at least one data processing apparatus to perform a method including: receiving, by a neighbor BS from a measuring BS, a message including a special subframe configuration code identifying a first special subframe configuration to be used by the measuring BS to measure interference, a cell ID of an interfering station and an interference type as either uplink (UL) interference or downlink (DL) interference; comparing, by the neighbor BS, the cell ID of the interfering station to a cell ID of the neighbor BS that received the message; and performing, by the neighbor BS, the following if the cell ID of the interfering station is the same as the cell ID of the neighbor BS: selecting, if the interference type is downlink interference, a second special subframe configuration for use by the neighbor BS where the downlink pilot time slot (DwPTS) of the second special subframe configuration is longer than the DwPTS of the first special subframe configuration; and selecting, if the interference type is uplink interference, a third special subframe configuration for use by the neighbor BS where the uplink pilot time slot (UpPTS) of the third special subframe configuration is longer than the UpPTS of the first special subframe configuration.

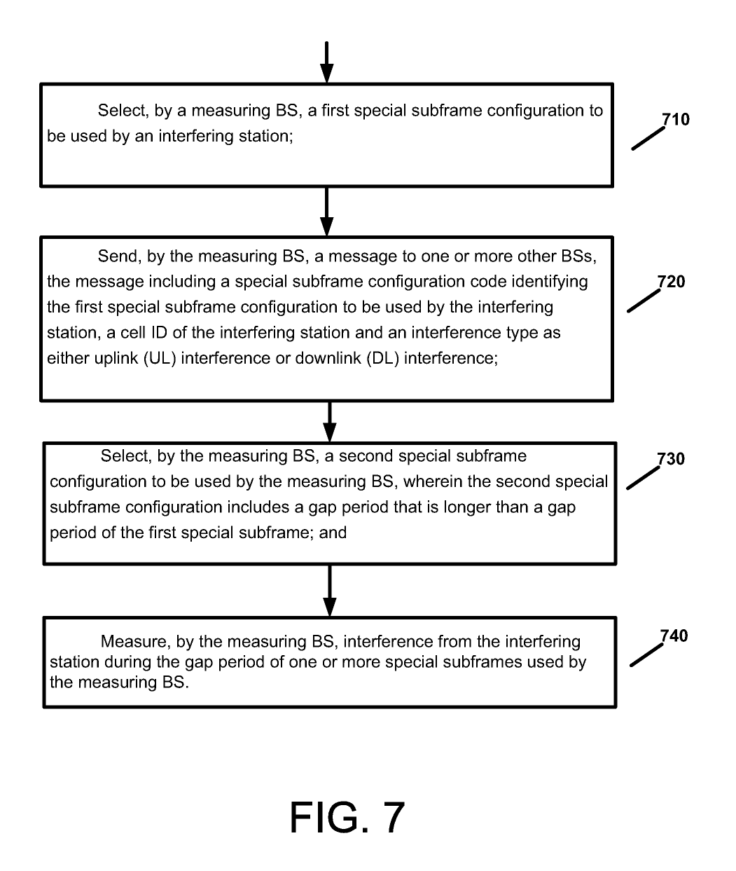

FIG. 7 is a flow chart illustrating operation of a measuring BS according to another example implementation. At 710, a measuring BS selects a first special subframe configuration to be used by an interfering station. At 720, the measuring BS sends a message to one or more other BSs, the message including a special subframe configuration code identifying the first special subframe configuration to be used by the interfering station, a cell ID of the interfering station and an interference type as either uplink (UL) interference or downlink (DL) interference. At 730, the measuring BS selects a second special subframe configuration to be used by the measuring BS, wherein the second special subframe configuration includes a guard period that is longer than a guard period of the first special subframe. At 740, the measuring BS measures interference from the interfering station during the guard period of one or more special subframes used by the measuring BS.

In the method of FIG. 7, according to an example implementation, the interference type may include downlink interference and wherein the interfering station includes an interfering BS, and wherein a downlink pilot time slot (DwPTS) of the first special subframe configuration used by the interfering BS is longer than a DwPTS of the second special subframe configuration used by the measuring BS such that at least a portion of the DwPTS of the first special subframe configuration overlaps at least a portion of a guard period of the second special subframe configuration.

In the method of FIG. 7, according to an example implementation, the interference type may include uplink interference and wherein the interfering station includes an interfering mobile station (MS) associated with the cell ID, and wherein an uplink pilot time slot (UpPTS) of the first special subframe configuration used by the interfering MS is longer than a UpPTS of the second special subframe configuration used by the measuring BS such that at least a portion of the UpPTS of the first special subframe configuration overlaps at least a portion of a guard period of the second special subframe configuration.

In the method of FIG. 7, the message further includes a start time and a measurement duration for the measuring of the interference from the interfering station.

According to an example implementation, an apparatus includes at least one processor and at least one memory including computer instructions, when executed by the at least one processor, cause the apparatus to: select, by a measuring BS, a first special subframe configuration to be used by an interfering station; send, by the measuring BS, a message to one or more other BSs, the message including a special subframe configuration code identifying the first special subframe configuration to be used by the interfering station, a cell ID of the interfering station and an interference type as either uplink (UL) interference or downlink (DL) interference; select, by the measuring BS, a second special subframe configuration to be used by the measuring BS, wherein the second special subframe configuration includes a guard period that is longer than a guard period of the first special subframe; and measure, by the measuring BS, interference from the interfering station during the guard period of one or more special subframes used by the measuring BS.

According to yet another example implementation, a computer program product is provided. The computer program product including a non-transitory computer-readable storage medium and storing executable code that, when executed by at least one data processing apparatus, is configured to cause the at least one data processing apparatus to perform a method including: selecting, by a measuring BS, a first special subframe configuration to be used by an interfering station; sending, by the measuring BS, a message to one or more other BSs, the message including a special subframe configuration code identifying the first special subframe configuration to be used by the interfering station, a cell ID of the interfering station and an interference type as either uplink (UL) interference or downlink (DL) interference; selecting, by the measuring BS, a second special subframe configuration to be used by the measuring BS, wherein the second special subframe configuration includes a guard period that is longer than a guard period of the first special subframe; and measuring, by the measuring BS, interference from the interfering station during the guard period of one or more special subframes used by the measuring BS.

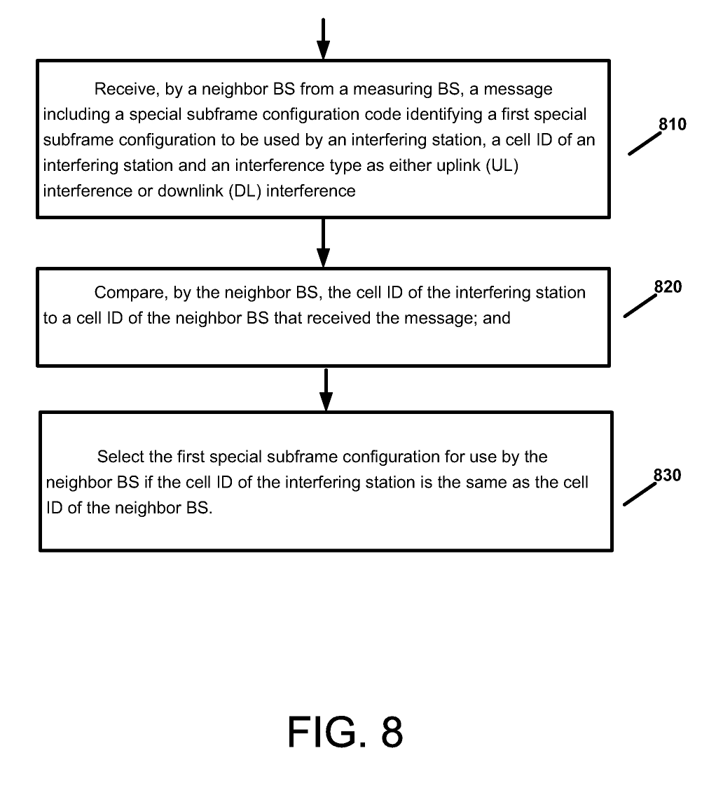

FIG. 8 is a flow chart illustrating an operation of a BS according to another example implementation. At 810, a neighbor BS receives from a measuring BS, a message including a special subframe configuration code identifying a first special subframe configuration to be used by an interfering station, a cell ID of an interfering station and an interference type as either uplink (UL) interference or downlink (DL) interference. At 820, the neighbor BS compares the cell ID of the interfering station to a cell ID of the neighbor BS that received the message. At 830, the first special subframe configuration is selected for use by the neighbor BS if the cell ID of the interfering station is the same as the cell ID of the neighbor BS.

In the method of FIG. 8, according to an example implementation, the method may further include performing, by the neighbor BS, the following if the cell ID of the interfering station is the same as the cell ID of the neighbor BS: transmitting, if the interference type is downlink interference, downlink data or cell-specific reference signal in a downlink pilot time slot (DwPTS) during one or more special subframes having the first special subframe configuration; and instructing, if the interference type is uplink interference, a mobile station (MS) associated with the neighbor BS to transmit in an uplink pilot time slot (UpPTS) during one or more special subframes having the first special subframe configuration.

In the method of FIG. 8, in an example implementation, the DwPTS or UpPTS of the first special subframe configuration are longer than a DwPTS or a UpPTS, respectively, of a second special subframe configuration used by the measuring BS.

In the method of FIG. 8, in an example implementation, the method may further include performing the following if the cell ID of the interfering station is not the same as the cell ID of the neighbor BS: selecting, if the interference type is downlink interference, a second special subframe configuration for use by the neighbor BS where the DwPTS of the second special subframe configuration is shorter than the DwPTS of the first special subframe configuration; and selecting, if the interference type is uplink interference, a third special subframe configuration for use by the neighbor BS where the UpPTS of the third special subframe configuration is shorter than the UpPTS of the first special subframe configuration.

According to an example implementation, an apparatus includes at least one processor and at least one memory including computer instructions, when executed by the at least one processor, cause the apparatus to: receive, by a neighbor BS from a measuring BS, a message including a special subframe configuration code identifying a first special subframe configuration to be used by an interfering station, a cell ID of the interfering station and an interference type as either uplink (UL) interference or downlink (DL) interference; compare, by the neighbor BS, the cell ID of the interfering station to a cell ID of the neighbor BS that received the message; and select the first special subframe configuration for use by the neighbor BS if the cell ID of the interfering station is the same as the cell ID of the neighbor BS.

According to an example implementation, a computer program product is provided. The computer program product includes a non-transitory computer-readable storage medium and storing executable code that, when executed by at least one data processing apparatus, is configured to cause the at least one data processing apparatus to perform a method including: receiving, by a neighbor BS from a measuring BS, a message including a special subframe configuration code identifying a first special subframe configuration to be used by an interfering station, a cell ID of the interfering station and an interference type as either uplink (UL) interference or downlink (DL) interference; comparing, by the neighbor BS, the cell ID of the interfering station to a cell ID of the neighbor BS that received the message; and selecting the first special subframe configuration for use by the neighbor BS if the cell ID of the interfering station is the same as the cell ID of the neighbor BS.

An illustrative or example IE (information element) is described below. This IE may include or may identify cell configuration information that may be received by a neighbor BS from a measuring BS. Thus, this IE may, for example, identify one or more parameters to be provided or communicated to adjacent or neighbor BSs via an X2 interface, for example.

| | | | | | | |
|---|---|---|---|---|---|---|
| >TDD | | | | | — | — |
| >>TDD Info | | 1 | | | — | — |
| >>>EARFCN | M | | 9.2.26 | Corresponds | — | — |
| | | | | to N_{DL}/N_{UL} | | |
| | | | | in TS 36.104 | | |
| | | | | [16] | | |
| >>>Transmission | M | | Transmission | | — | — |
| Bandwidth | | | Bandwidth 9.2.27 | | | |
| >>>Subframe | M | | ENUMERATED(sa0, | Uplink- | — | — |
| Assignment | | | sa1, sa2, sa3, sa4, | downlink | | |
| | | | sa5, sa6, . . .) | subframe | | |
| | | | | configuration | | |
| | | | | information | | |
| | | | | defined in TS | | |
| | | | | 36.211 [10] | | |
| >>>Special | | 1 | | Special | — | — |
| Subframe Info | | | | subframe | | |
| | | | | configuration | | |
| | | | | information | | |
| | | | | defined in TS | | |
| | | | | 36.211 [10] | | |
| >>>>Special | M | | ENUMERATED(ssp0, | | — | — |
| Subframe Patterns | | | ssp1, ssp2, ssp3, | | | |
| | | | ssp4, ssp5, ssp6, | | | |
| | | | ssp7, ssp8, . . .) | | | |
| >>EARFCN | O | | 9.2.65 | If this IE is | YES | reject |
| Extension | | | | present, the | | |
| | | | | value | | |
| | | | | signalled in | | |
| | | | | the EARFCN | | |
| | | | | IE is ignored. | | |
| >>>>Cyclic Prefix | M | | ENUMERATED(Normal, | | — | — |
| DL | | | Extended, . . .) | | | |
| >>>>Cyclic Prefix | M | | ENUMERATED(Normal, | | — | — |
| UL | | | Extended, . . .) | | | |
| >>>Additional | O | | | Special | GLOBAL | ignore |
| Special Subframe | | | | subframe | | |
| Info | | | | configuration | | |
| | | | | information | | |
| | | | | defined in | | |
| | | | | TS 36.211 | | |
| | | | | [10]. Only | | |
| | | | | for newly | | |
| | | | | defined | | |
| | | | | configuration | | |
| | | | | of special | | |
| | | | | subframe | | |
| | | | | from | | |
| | | | | Release 11. | | |
| >>>>Additional | M | | ENUMERATED(ssp0, | | — | — |
| Special Subframe | | | ssp1, ssp2, ssp3, | | | |
| Patterns | | | ssp4, ssp5, ssp6, | | | |
| | | | ssp7, ssp8, ssp9, . . .) | | | |
| >>>Interference | O | | | Special | | |
| measurement Info | | | | subframe | | |
| | | | | configuration | | |
| | | | | information | | |
| | | | | defined in | | |
| | | | | TS 36.211 | | |
| | | | | [10]. Only | | |
| | | | | for newly | | |
| | | | | defined | | |
| | | | | configuration | | |
| | | | | of special | | |
| | | | | subframe | | |
| | | | | from | | |
| | | | | Release 12. | | |
| >>>>Interference | M | | ENUMERATED(down- | Interference | | |
| type to be measured | | | link, uplink) | to be | | |
| | | | | measured | | |
| | | | | from | | |
| | | | | neighboring | | |
| | | | | cell's | | |
| | | | | downlink | | |
| | | | | transmission | | |
| | | | | or uplink | | |
| | | | | transmission | | |
| >>>>time info for | M | | Time Information | Indicating | | |
| interference | | | | a Specific | | |
| measurement | | | | radio frame | | |
| | | | | to start | | |
| | | | | interference | | |
| | | | | measurement | | |
| >>>>measurement | M | | INTEGER (1, 2, . . .) | Suggested | | |
| duration | | | | number of | | |
| | | | | radio frames | | |
| | | | | for eNB to | | |
| | | | | keep SSF | | |
| | | | | configuration | | |
| | | | | since | | |
| | | | | indicated | | |
| | | | | frame | | |
| >>>>Special | M | | ENUMERATED(ssp0, | Special | — | — |
| Subframe Patterns | | | ssp1, ssp2, ssp3, | subframe | | |
| in the frame for | | | ssp4, ssp5, ssp6, | configuration | | |
| interference | | | ssp7, ssp8, ssp9, | selection | | |
| measurement | | | ssp10, ssp11, ssp12, | needs to | | |
| | | | ssp13, ssp14, ssp15, . . .) | consider the | | |
| | | | | interference | | |
| | | | | type to be | | |
| | | | | measured. | | |
| >>>> Cell ID of the | M | | INTEGER(0, 1, 2, . . .) | Cell ID | | |
| interferer to be | | | | of the | | |
| measured | | | | interferer to | | |
| | | | | be measured | | |
| >>>>Cyclic Prefix | M | | ENUMERATED(Normal, | | — | — |
| DL | | | Extended, . . .) | | | |
| >>>>Cyclic Prefix | M | | ENUMERATED(Normal, | | — | — |
| UL | | | Extended, . . .) | | | |
| Number of Antenna | O | | 9.2.43 | | YES | ignore |
| Ports | | | | | | |
| PRACH | O | | PRACH | | YES | ignore |
| Configuration | | | Configuration 9.2.50 | | | |

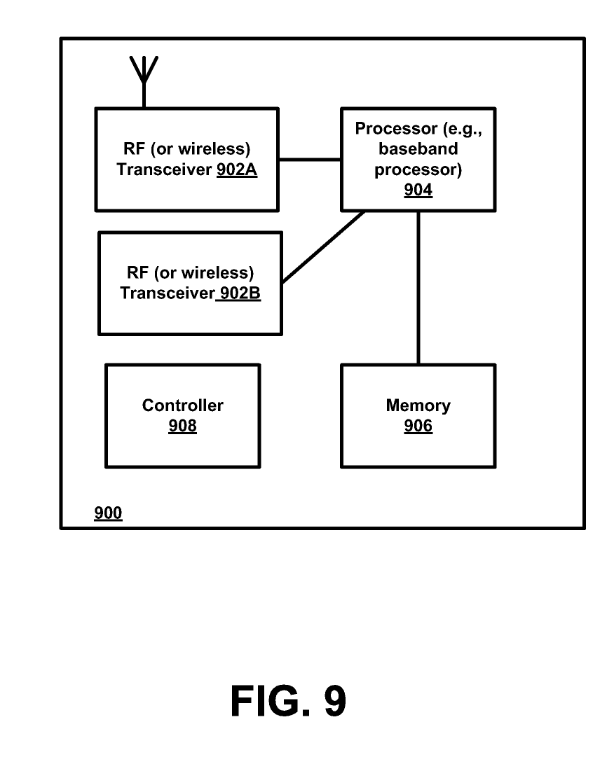

FIG. 9 is a block diagram of a wireless station (e.g., BS or MS) 900 according to an example implementation. The wireless station 900 may include, for example, two RF (radio frequency) or wireless transceivers 902A, 902B, where each wireless transceiver includes a transmitter to transmit signals and a receiver to receive signals. The wireless station also includes a processor 904 to execute instructions or software and control transmission and receptions of signals, and a memory 906 to store data and/or instructions.

Processor 904 may also make decisions or determinations, generate frames, packets or messages for transmission, decode received frames or messages for further processing, and other tasks or functions described herein. Processor 904, which may be a baseband processor, for example, may generate messages, packets, frames or other signals for transmission via wireless transceiver 902. Processor 904 may control transmission of signals or messages over a wireless network, and may receive signals or messages, etc., via a wireless network (e.g., after being down-converted by wireless transceiver 902, for example). Processor 904 may be programmable and capable of executing software or other instructions stored in memory or on other computer media to perform the various tasks and functions described above, such as one or more of the tasks or methods described above. Processor 904 may be (or may include), for example, hardware, programmable logic, a programmable processor that executes software or firmware, and/or any combination of these. Using other terminology, processor 904 and transceiver 902 together may be considered as a wireless transmitter/receiver system, for example.

In addition, referring to FIG. 9, a controller (or processor) 908 may execute software and instructions, and may provide overall control for the station 900, and may provide control for other systems not shown in FIG. 9, such as controlling input/output devices (e.g., display, keypad), and/or may execute software for one or more applications that may be provided on wireless station 900, such as, for example, an email program, audio/video applications, a word processor, a Voice over IP application, or other application or software.

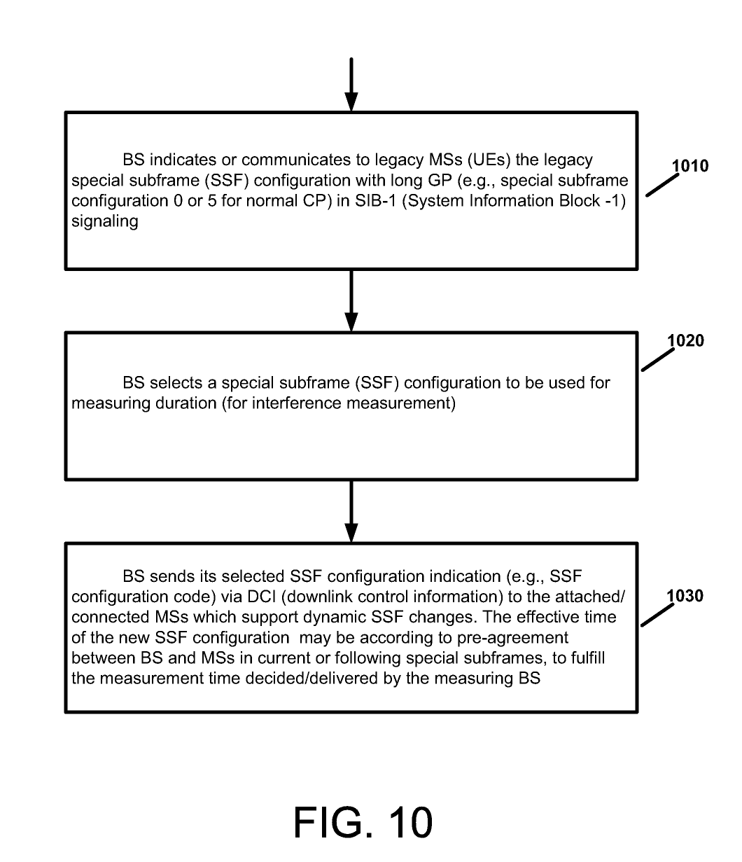

FIG. 10 is a flow chart illustrating operation of a base station according to yet another example implementation. At 1010, a BS indicates or communicates to legacy MSs (UEs) the legacy special subframe (SSF) configuration with long GP (e.g., special subframe configuration 0 or 5 for normal CP) in SIB-1 (System Information Block-1) signalling. At 1020, the BS selects a special subframe (SSF) configuration to be used for measuring duration (for interference measurement). At 1030, the BS sends its selected SSF configuration indication (e.g., SSF configuration code) via DCI (downlink control information) to the attached/connected MSs which support dynamic SSF changes. The effective time of the new SSF configuration may be according to pre-agreement between BS and MSs in current or following special subframes, to fulfill the measurement time decided/delivered by the measuring BS. In an example implementation, one or more (or all) of the measuring BS, the measured BS, and non-measured BSs may each similarly perform operations of 1010 (notify legacy MSs of long GP SSF configuration), 1020 (select a SSF configuration) and 1030 (e.g., notify one or more connected/attached MSs of selected SSF configuration via DCI).

In addition, a storage medium may be provided that includes stored instructions, which when executed by a controller or processor may result in the processor 904, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1.-11. (canceled)

12. A method comprising:
receiving, by a neighbor BS from a measuring BS, a message including a special subframe configuration code identifying a first special subframe configuration to be used by the measuring BS to measure interference, a cell ID of an interfering station and an interference type as either uplink (UL) interference or downlink (DL) interference;
comparing, by the neighbor BS, the cell ID of the interfering station to a cell ID of the neighbor BS that received the message; and
performing, by the neighbor BS, the following if the cell ID of the interfering station is the same as the cell ID of the neighbor BS:
selecting, if the interference type is downlink interference, a second special subframe configuration for use by the neighbor BS where the downlink pilot time slot (DwPTS) of the second special subframe configuration is longer than the DwPTS of the first special subframe configuration; and
selecting, if the interference type is uplink interference, a third special subframe configuration for use by the neighbor BS where the uplink pilot time slot (UpPTS) of the third special subframe configuration is longer than the UpPTS of the first special subframe configuration.

13. The method of claim 12 and further comprising the neighbor BS notifying one or more mobile stations (MSs) via downlink control information (DCI) of the special subframe configuration selected for use by the neighbor BS.

14. The method of claim 12 and further comprising performing the following if the cell ID of the interfering station is not the same as the cell ID of the neighbor BS:
selecting, if the interference type is downlink interference, a fourth special subframe configuration for use by the neighbor BS where the DwPTS of the fourth special subframe configuration is not longer than the DwPTS of the first special subframe configuration; and
selecting, if the interference type is uplink interference, a fifth special subframe configuration for use by the neighbor BS where the UpPTS of the fifth special subframe configuration is not longer than the UpPTS of the first special subframe configuration.

15. The method of claim 12 wherein at least a portion of a guard period of a special subframe having the first special subframe configuration overlaps at least a portion of the DwPTS of a special subframe having the second special subframe configuration if the interference type is downlink interference to allow the measuring BS to measure the DwPTS from the neighbor BS during the guard period of the special subframe used by the measuring BS.

16. The method of claim 12 wherein at least a portion of a guard period of a special subframe having the first special subframe configuration overlaps at least a portion of the UpPTS of a special subframe having the third special subframe configuration if the interference type is uplink to allow the measuring BS to measure the signals transmitted in the UpPTS from a mobile station (MS) associated with the neighbor BS of the cell ID during a guard period of the special subframe used by the measuring BS.

17. The method of claim 12 wherein the message further includes a start time and a measurement duration for the measuring of the interference from the interfering station.

18. The method of claim 12 and further comprising the neighbor BS notifying one or more mobile stations (MSs) of the special subframe configuration selected by the neighbor BS via DCI (DL Control Information).

19. The method of claim 12, wherein the interference type is uplink interference, and the method further comprising the neighbor BS of the cell ID scheduling a mobile station associated with the neighbor BS to transmit during the UpPTS of one or more special subframes having the special subframe configuration selected by the neighbor BS for use by the neighbor BS.

20. An apparatus comprising at least one processor and at least one memory including computer instructions, when executed by the at least one processor, cause the apparatus to:
receive, by a neighbor BS from a measuring BS, a message including a special subframe configuration code identifying a first special subframe configuration to be used by the measuring BS to measure interference, a cell ID of an interfering station and an interference type as either uplink (UL) interference or downlink (DL) interference;
compare, by the neighbor BS, the cell ID of the interfering station to a cell ID of the neighbor BS that received the message; and
perform, by the neighbor BS, the following if the cell ID of the interfering station is the same as the cell ID of the neighbor BS:
select, if the interference type is downlink interference, a second special subframe configuration for use by the neighbor BS where the downlink pilot time slot (DwPTS) of the second special subframe configuration is longer than the DwPTS of the first special subframe configuration; and
select, if the interference type is uplink interference, a third special subframe configuration for use by the neighbor BS where the uplink pilot time slot (UpPTS) of the third special subframe configuration is longer than the UpPTS of the first special subframe configuration.

21.-27. (canceled)

28. A method comprising:
receiving, by a neighbor BS from a measuring BS, a message including a special subframe configuration code identifying a first special subframe configuration to be used by an interfering station, a cell ID of an interfering station and an interference type as either uplink (UL) interference or downlink (DL) interference;
comparing, by the neighbor BS, the cell ID of the interfering station to a cell ID of the neighbor BS that received the message; and
selecting the first special subframe configuration for use by the neighbor BS if the cell ID of the interfering station is the same as the cell ID of the neighbor BS.

29. The method of claim 28 and further comprising performing, by the neighbor BS, the following if the cell ID of the interfering station is the same as the cell ID of the neighbor BS:
transmitting, if the interference type is downlink interference, in a downlink pilot time slot (DwPTS) during one or more special subframes having the first special subframe configuration; and
instructing, if the interference type is uplink interference, a mobile station (MS) associated with the neighbor BS to transmit in an uplink pilot time slot (UpPTS) during one or more special subframes having the first special subframe configuration.

30. The method of claim 29 wherein the DwPTS and UpPTS of the first special subframe configuration are longer than a DwPTS and a UpPTS, respectively, of a second special subframe configuration used by the measuring BS.

31. The method of claim 28 and further comprising performing the following if the cell ID of the interfering station is not the same as the cell ID of the neighbor BS:
selecting, if the interference type is downlink interference, a second special subframe configuration for use by the neighbor BS where the DwPTS of the second special subframe configuration is shorter than the DwPTS of the first special subframe configuration; and
selecting, if the interference type is uplink interference, a third special subframe configuration for use by the neighbor BS where the UpPTS of the third special subframe configuration is shorter than the UpPTS of the first special subframe configuration.

32. The method of claim 28 and further comprising the neighbor BS notifying one or more mobile stations (MSs) of the special subframe configuration selected by the neighbor BS via DCI (DL Control Information), the BS identifying the mobile stations which support the DCI indicator of special subframe configuration and one or more of the mobile stations indicating their capability of supporting the DCI indicator of special subframe configuration.

33. An apparatus comprising at least one processor and at least one memory including computer instructions, when executed by the at least one processor, cause the apparatus to:
receive, by a neighbor BS from a measuring BS, a message including a special subframe configuration code identifying a first special subframe configuration to be used by an interfering station, a cell ID of the interfering station and an interference type as either uplink (UL) interference or downlink (DL) interference;
compare, by the neighbor BS, the cell ID of the interfering station to a cell ID of the neighbor BS that received the message; and
select the first special subframe configuration for use by the neighbor BS if the cell ID of the interfering station is the same as the cell ID of the neighbor BS.

34. (canceled)
